(19) United States
(12) Patent Application Publication
(10) Pub. No.: US 2018/0278457 A1
(43) Pub. Date: Sep. 27, 2018

(54) COMMUNICATION DEVICE AND DISTORTION COMPENSATION METHOD

(71) Applicant: FUJITSU LIMITED, Kawasaki-shi (JP)

(72) Inventor: Shinichiro Kobayashi, Yokohama (JP)

(73) Assignee: FUJITSU LIMITED, Kawasaki-shi (JP)

(21) Appl. No.: 15/923,729

(22) Filed: Mar. 16, 2018

(30) Foreign Application Priority Data
Mar. 24, 2017 (JP) 2017-060076

(51) Int. Cl. H04L 27/36; H04B 17/20; H04B 17/10; H04L 27/38

(52) U.S. Cl. CPC H04L 27/366; H04L 27/38; H04B 17/10; H04B 17/20

(57) ABSTRACT

A communication device includes a transmitter that transmits a transmission signal during a transmission time-period, the transmitter to include, a modulator to modulate the transmission signal, and a transmission-side distortion compensator to measure spurious characteristics of the modulator during a time-period other than the transmission time-period and add, during the transmission time-period, a compensation signal indicating reverse characteristics of the spurious characteristics of the modulator to the transmission signal before the input of the transmission signal to the modulator, and a receiver that receives a reception signal during a reception time-period, the receiver to include, a demodulator to demodulate the reception signal, and a reception-side distortion compensator to measure spurious characteristics of the demodulator during a time-period other than the reception time-period and adds, during the reception time-period, a compensation signal indicating reverse characteristics of the spurious characteristics of the demodulator to the reception signal output from the demodulator.

### CROSS-REFERENCE TO RELATED APPLICATION

This application is based upon and claims the benefit of priority of the prior Japanese Patent Application No. 2017-060076, filed on Mar. 24, 2017, the entire contents of which are incorporated herein by reference.

### FIELD

The embodiments discussed herein are related to a communication device and a distortion compensation method.

### BACKGROUND

A communication device using a direct conversion scheme is known. The communication device using the direct conversion scheme has a frequency range in which an intermediate frequency (IF) is set to 0 Hz by a superheterodyne scheme, which is widely used by radiobroadcast receivers and the like. Thus, the direct conversion scheme is also referred to as Zero-IF scheme. Since the communication device using the direct conversion scheme is easily formed in a large scale integration (LSI), compared with a communication device using the superheterodyne scheme, there are advantages such as the downsizing of the communication device using the direct conversion scheme, a reduction in power to be consumed by the communication device using the direct conversion scheme, and a reduction in the cost of manufacturing the communication device using the direct conversion scheme.

The communication device using the direct conversion scheme includes a transmitter (TX) and a receiver (RX). The TX transmits a transmission signal as a radio signal during a transmission time period. The RX receives a radio signal as a reception signal during a reception time period.

For example, in the TX, a modulator modulates the transmission signal before the transmission of the transmission signal as the radio signal. In general, the modulator includes a local oscillator and a frequency converter. Thus, in the communication device using the direct conversion scheme, direct current (DC) leakage of the local oscillator of the modulator causes a spurious emission (unrequired wave). The DC leakage is also referred to as DC offset.

In addition, in the RX, a demodulator demodulates the reception signal when the RX receives the radio signal as the reception signal. The demodulator includes a local oscillator and a frequency converter, like the modulator. Thus, in the communication device using the direct conversion scheme, DC leakage of the local oscillator of the demodulator causes a spurious emission.

Examples of related art are Japanese Laid-open Patent Publications Nos. 7-74790, 2006-136028, 2008-98781, and 2009-253518.

### SUMMARY

According to an aspect of the invention, a communication device includes a transmitter that transmits a transmission signal during a transmission time period, the transmitter configured to include, a modulator configured to modulate the transmission signal, and a transmission-side distortion compensator configured to measure spurious characteristics of the modulator during a time period other than the transmission time period and add, during the transmission time period, a compensation signal indicating reverse characteristics of the spurious characteristics of the modulator to the transmission signal before the input of the transmission signal to the modulator, and a receiver that receives a reception signal during a reception time period, the receiver configured to include, a demodulator configured to demodulate the reception signal, and a reception-side distortion compensator configured to measure spurious characteristics of the demodulator during a time period other than the reception time period and adds, during the reception time period, a compensation signal indicating reverse characteristics of the spurious characteristics of the demodulator to the reception signal output from the demodulator.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication device according to a first embodiment;

FIG. 2 is a timing chart of an example of operations of an RX of the communication device according to the first embodiment;

FIG. 3 is a flowchart of the example of the operations of the RX of the communication device according to the first embodiment;

FIG. 4 is a timing chart of an example of operations of a TX of the communication device according to the first embodiment;

FIG. 5 is a flowchart of the example of the operations of the TX of the communication device according to the first embodiment;

FIG. 6 is a diagram describing an effect of the communication device according to the first embodiment;

FIG. 7 is a diagram illustrating an example of a communication device according to a second embodiment;

FIG. 8 is a diagram illustrating an example of a hardware configuration of each of the communication devices;

FIG. 9 is a diagram illustrating the relationship between a DC position and a carrier alignment; and

FIG. 10 is a diagram illustrating the relationship between a high-pass filter and the carrier alignment.

### DESCRIPTION OF EMBODIMENTS

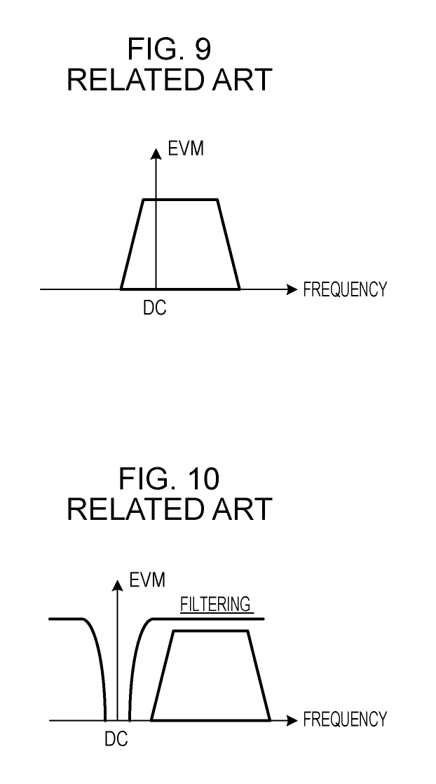

FIG. 9 is a diagram illustrating the relationship between a DC position and a carrier alignment. In FIG. 9, the abscissa indicates a frequency, and the ordinate indicates an error vector magnitude (EVM). As illustrated in FIG. 9, for example, if DC leakage is superimposed on a radio signal, the performance of the radio signal is reduced.

FIG. 10 is a diagram illustrating the relationship between a high-pass filter and the carrier alignment. In FIG. 10, the abscissa indicates a frequency, and the ordinate indicates an EVM. For example, a spurious emission (DC leakage) may be attenuated by the high-pass filter. As illustrated in FIG. 10, however, a carrier is aligned to inhibit a radio signal from being attenuated by the high-pass filter. Thus, in the case where a filter such as the high-pass filter is used, it is not possible to take full advantage of a frequency band of a modulator and a demodulator.

Hereinafter, embodiments of a technique for compensating for a signal distortion caused by a spurious emission without using a filter are described in detail with reference to the accompanying drawings. The embodiments, however, do not limit techniques disclosed herein.

### First Embodiment

Configuration of Communication Device

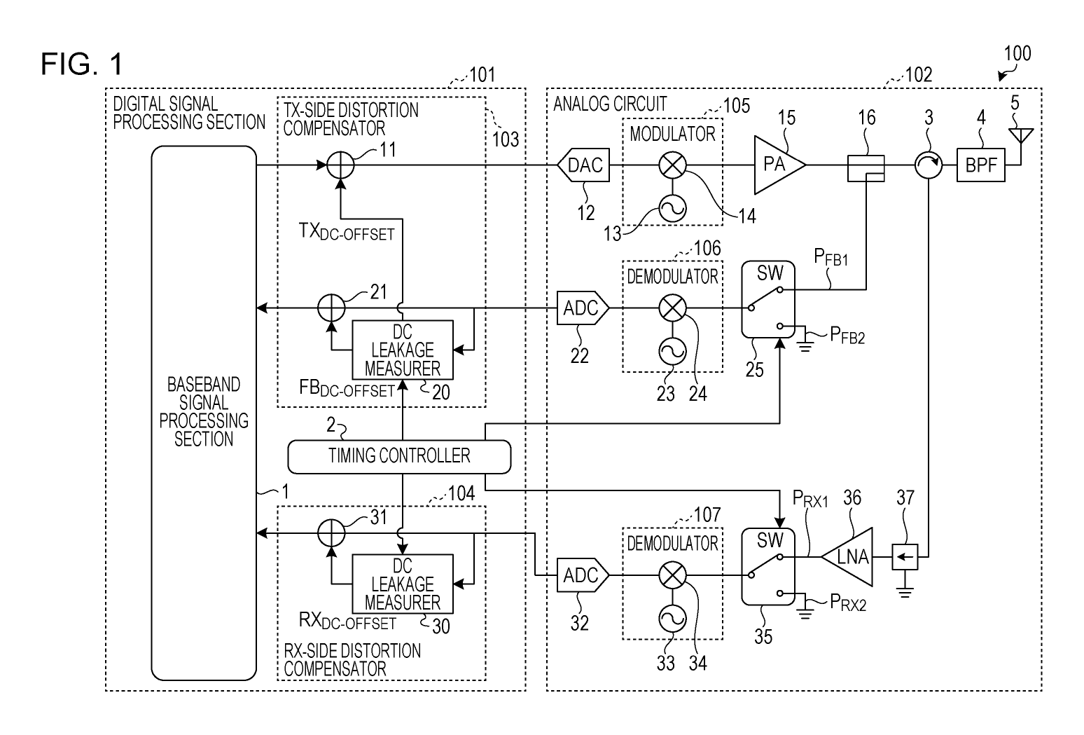

FIG. 1 is a block diagram illustrating an example of a communication device 100 according to a first embodiment. The communication device 100 includes a digital signal processing section 101 and an analog circuit 102.

The analog circuit 102 includes a digital-to-analog converter (DAC) 12, a modulator 105, a power amplifier (PA) 15, a coupler 16, a circulator 3, a band-pass filter (BPF) 4, and an antenna 5. The modulator 105 includes a local oscillator (LO) 13 and a frequency converter 14.

The analog circuit 102 also includes an analog-to-digital converter (ADC) 22, a demodulator 106, and a switch (SW) 25. The demodulator 106 includes an LO 23 and a frequency converter 24.

The analog circuit 102 also includes an ADC 32, a demodulator 107, an SW 35, a low noise amplifier (LNA) 36, and an isolator (ISO) 37. The demodulator 107 includes an LO 33 and a frequency converter 34.

The digital signal processing section 101 includes a baseband signal processing section 1, a timing controller 2, a transmission-side (TX-side) distortion compensator 103, and a reception-side (RX-side) distortion compensator 104. The timing controller 2 controls the entire communication device 100. The TX-side distortion compensator 103 includes adders 11 and 21 and a direct current (DC) leakage measurer 20. The RX-side distortion compensator 104 includes an adder 31 and a DC leakage measurer 30.

The communication device 100 uses a direct conversion scheme and includes a transmitter (TX) and a receiver (RX). The TX transmits a transmission signal as a radio signal during each of transmission time periods (TX time periods). The RX receives a radio signal as a reception signal during each of reception time periods (RX time periods). Thus, the communication device 100 has the RX time periods, the TX time periods, and switch time periods (GAP time periods) between the TX time periods and the RX time periods.

Configuration of RX

The digital signal processing section 101 of the RX includes the baseband signal processing section 1, the timing controller 2, and the RX distortion compensator 104 (including the adder 31 and the DC leakage measurer 30). In addition, the analog circuit 102 of the RX includes the ADC 32, the demodulator 107 (including the LO 33 and the frequency converter 34), the SW 35, the LNA 36, the ISO 37, the circulator 3, the BPF 4, and the antenna 5.

First, the analog circuit 102 of the RX is described.

The antenna 5 receives a high-frequency radio signal.

The BPF 4 receives the radio signal received by the antenna 5. The BPF 4 causes a signal, included in the radio signal, in a specific frequency band to pass through the BPF 4 and attenuates a signal, included in the radio signal, in a frequency band other than the specific frequency band. The signal that has passed through the BPF 4 serves as a reception signal and is output to the LNA 36 via the circulator 3 and the ISO 37.

The LNA 36 receives the reception signal output from the BPF 4 via the circulator 3 and the ISO 37. The LNA 36 amplifies power of the received reception signal and outputs the reception signal to the SW 35.

The SW 35 includes two inputs and one output. One of the inputs of the SW 35 is connected to an output of the LNA 36 via a reception path P_{RX1}. The other of the inputs of the SW 35 is terminated (grounded) via a terminal path P_{RX2}. The SW 35 switches between the paths P_{RX1} and P_{RX2} based on a control signal. The control signal indicates a first value or a second value.

The SW 35 is installed to distinguish between the reception signal received by the RX and DC leakage that occurs in the demodulator 107 of the analog circuit 102 of the RX.

For example, during an RX time period, the timing controller 2 supplies the control signal indicating the second value to the SW 35. In this case, the SW 35 selects the reception path P_{RX1}. In this case, the radio signal is output as a reception signal from the antenna 5 to the digital signal processing section 101 via the BPF 4, the circulator 3, the ISO 37, the LNA 36, the reception path P_{RX1}, the SW 35, the demodulator 107, and the ADC 32.

For example, during a TX time period and a GAP time period, the timing controller 2 supplies the control signal indicating the first value to the SW 35. In this case, the SW 35 selects the terminal path P_{RX2}. In this case, a signal is output from the demodulator 107 having an input terminated by the terminal path P_{RX2} to the digital signal processing section 101 via the ADC 32.

The RX-side distortion compensator 104 of the digital signal processing section 101 of the RX monitors a signal output from the analog circuit 102 during the TX time period and the GAP time period, thereby compensating for DC leakage characteristics of the demodulator 107 during an RX time period.

The demodulator 107 executes the following demodulation process. For example, in the demodulation process, the LO 33 supplies a standard carrier wave signal to the frequency converter 34. The frequency converter 34 receives the signal output from the SW 35. The frequency converter 34 multiplies the signal received from the SW 35 by the standard carrier wave signal supplied from the LO 33, thereby generating a frequency-converted signal. The frequency converter 34 outputs the generated signal to the ADC 32.

The ADC 32 converts the signal output from the demodulator 107 into a digital signal, thereby generating a baseband signal having I and Q channel signals with phases orthogonal to each other. The ADC 32 outputs the generated baseband signal as a reception signal to the digital signal processing section 101.

Next, the digital signal processing section 101 of the RX is described.

The timing controller 2 outputs the control signal indicating the first value or the second value. For example, during a TX time period and a GAP time period, the timing controller 2 outputs the control signal indicating the first value to the SW 35 and the RX-side distortion compensator 104. In addition, during an RX time period, the timing controller 2 outputs the control signal indicating the second value to the SW 35 and the RX-side distortion compensator 104.

In the RX-side distortion compensator 104, the DC leakage measurer 30 executes the following process.

For example, during a TX time period and a GAP time period, the timing controller 2 supplies the control signal indicating the first value to the DC leakage measurer 30. In this case, the DC leakage measurer 30 measures, based on the signal output from the analog circuit 102, DC leakage characteristics indicating the level (amplitude) and phase of DC leakage that occurs in the demodulator 107 of the RX, and the DC leakage measurer 30 calculates reverse characteristics of the measured DC leakage characteristics.

For example, during an RX time period after the aforementioned GAP time period, the timing controller 2 supplies the control signal indicating the second value to the DC leakage measurer 30. In this case, the DC leakage measurer 30 outputs, to the adder 31, a compensation signal RX_{DC-OFFSET} indicating the calculated reverse characteristics of the DC leakage characteristics of the demodulator 107.

During the aforementioned RX time period, the adder 31 receives the reception signal (baseband signal) output from the analog circuit 102. In addition, the adder 31 receives the compensation signal RX_{DC-OFFSET} from the DC leakage measurer 30. Then, the adder 31 adds the compensation signal RX_{DC-OFFSET} received from the DC leakage measurer 30 to the reception signal output from the analog circuit 102. As a result, the DC leakage characteristics of the demodulator 107 of the RX are compensated. The reception signal to which the compensation signal RX_{DC-OFFSET} has been added is output to the baseband signal processing section 1.

The baseband signal processing section 1 receives the reception signal (baseband signal) output from the adder 31 and acquires the I channel signal and the Q channel signal from the baseband signal.

Configuration of TX

The digital signal processing section 101 of the TX includes the baseband signal processing section 1, the timing controller 2, and the TX-side distortion compensator 103 (including the adders 11 and 21 and the DC leakage measurer 20). In addition, the analog circuit 102 of the TX includes the DAC 12, the modulator 105 (including the LO 13 and the frequency converter 14), the PA 15, the coupler 16, the circulator 3, the BPF 4, and the antenna 5. The analog circuit 102 of the TX also includes the ADC 22, the demodulator 106 (including the LO 23 and the frequency converter 24) and the SW 25.

First, the digital signal processing section 101 of the TX is described below.

The baseband signal processing section 1 generates a baseband signal having I and Q channel signals with phases orthogonal to each other. The baseband signal processing section 1 outputs the generated baseband signal as a transmission signal to the TX-side distortion compensator 103.

The timing controller 2 outputs the control signal indicating the first value or the second value. For example, the timing controller 2 outputs the control signal indicating the first value to the SW 25 and the TX-side distortion compensator 103 during a TX time period and a switch time period (GAP time period) switched from the TX time period and to be switched to an RX time period. In addition, the timing controller 2 outputs the control signal indicating the second value to the SW 25 and the TX-side distortion compensator 103 during the RX time period and a switch time period (GAP time period) switched from the RX time period and to be switched to a TX time period.

The adder 11 receives the transmission signal (baseband signal) output from the baseband signal processing section 1. The adder 11 adds a compensation signal TX_{DC-OFFSET} (described later) to the received transmission signal and outputs the transmission signal having the compensation signal TX_{DC-OFFSET} added thereto to the analog circuit 102.

Next, the analog circuit 102 of the TX is described.

The DAC 12 receives the transmission signal (baseband signal) output from the adder 11. The DAC 12 converts the received transmission signal into an analog signal and outputs the analog signal to the modulator 105.

The modulator 105 executes the following modulation process. For example, in the modulation process, the LO 13 supplies a standard carrier wave signal to the frequency converter 14. The frequency converter 14 receives the signal output from the DAC 12. The frequency converter 14 multiplies the received signal by the standard carrier wave signal supplied from the LO 13, thereby generating a frequency-converted signal. The frequency converter 14 outputs the generated signal as a transmission signal to the PA 15.

The PA 15 receives the transmission signal output from the modulator 105. The PA 15 amplifies the received transmission signal and outputs the amplified transmission signal to the coupler 16.

The coupler 16 receives the transmission signal from the PA 15. The coupler 16 outputs the received transmission signal to the BPF 4 via the circulator 3. In addition, the coupler 16 outputs the received transmission signal to the SW 25 via a feedback path P_{FB1}.

The BPF 4 receives the transmission signal output from the coupler 16 via the circulator 4. The BPF 4 causes a signal, included in the transmission signal, in a specific frequency band to pass through the BPF 4 and attenuates a signal, included in the transmission signal, in a frequency band other than the specific frequency band. The signal that has passed through the BPF 4 is output as a radio signal from the antenna 5.

The SW 25 includes two inputs and one output. One of the inputs of the SW 25 is connected to an output of the coupler 16 via the feedback path P_{FB1}. The other of the inputs of the SW 25 is terminated (grounded) via a terminal path P_{FB2}. The SW 25 switches between the paths P_{FB1} and P_{FB2} based on a control signal. The control signal indicates the first value or the second value.

The SW 25 is installed to distinguish between DC leakage that occurs in the modulator 105 of the analog circuit 102 of the TX and DC leakage that occurs in the demodulator 106 of the analog circuit 102 of the TX.

For example, during an RX time period and a switch time period (GAP time period) switched from the RX time period and to be switched to a TX time period, the timing controller 2 supplies the control signal indicating the second value to the SW 25. In this case, the SW 25 selects the terminal path P_{FB2}. In this case, a signal is output from the demodulator 106 having an input terminated by the terminal path P_{FB2} to the digital signal processing section 101 via the ADC 22.

For example, during a TX time period, the timing controller 2 supplies the control signal indicating the first value to the SW 25. In this case, the SW 25 selects the feedback path P_{FB1}. In this case, the transmission signal is fed back from the digital signal processing section 101 via the DAC 12, the modulator 105, the PA 15, the coupler 16, the feedback path P_{FB1}, the SW 25, the demodulator 106, and the ADC 22 to the digital signal processing section 101.

During a switch time period (GAP time period) switched from the TX time period and to be switched to an RX time period, the timing controller 2 supplies the control signal indicating the first value to the SW 25. In this case, the signal is output from the modulator 105 via the PA 15, the coupler 16, the feedback path P_{FB1}, the SW 25, the demodulator 106, and the ADC 22 to the digital signal processing section 101. For example, if a power supply of the PA 15 is in an OFF state during the RX time period, the aforementioned signal is not output during a GAP time period after the RX time period and is output during the GAP time period after the TX time period.

First, the TX-side distortion compensator 103 of the digital signal processing section 101 of the TX monitors the signal output from the analog circuit 102 during an RX time period and a GAP time period after the RX time period, thereby compensating for DC leakage characteristics of the demodulator 106 during a TX time period. After that, the TX-side distortion compensator 103 of the digital signal processing section 101 of the TX monitors the signal output from the analog circuit 102 during a GAP time period after the TX time period, thereby compensating for DC leakage characteristics of the modulator 105 during the next TX time period.

The demodulator 106 executes the following demodulation process. For example, in the demodulation process, the LO 23 supplies a standard carrier wave signal to the frequency converter 24. The frequency converter 24 receives the signal output from the SW 25. The frequency converter 24 multiplies the received signal by the standard carrier wave signal supplied from the LO 23, thereby generating a frequency-converted signal. The frequency converter 24 outputs the generated signal to the ADC 22.

The ADC 22 converts the signal output from the demodulator 106 into a digital signal, thereby generating a baseband signal having I and Q channel signals with phases orthogonal to each other. The ADC 22 outputs the generated baseband signal as a transmission signal to the digital signal processing section 101.

Next, the TX-side distortion compensator 103 of the digital signal processing section 101 of the TX is described.

First, the DC leakage measurer 20 executes the following process.

For example, during an RX time period and a switch time period (GAP time period) switched from the RX time period and to be switched to a TX time period, the timing controller 2 supplies the control signal indicating the second value to the DC leakage measurer 20. In this case, the DC leakage measurer 20 measures, based on the signal output from the analog circuit 102, DC leakage characteristics indicating the level (amplitude) and phase of DC leakage that occurs in the demodulator 106 of the TX, and the DC leakage measurer 20 calculates reverse characteristics of the measured DC leakage characteristics.

For example, during the TX time period after the aforementioned GAP time period, the timing controller 2 supplies the control signal indicating the first value to the DC leakage measurer 20. In this case, the DC leakage measurer 20 outputs, to the adder 21, a compensation signal FB_{DC-OFFSET} indicating the calculated reverse characteristics of the DC leakage characteristics of the demodulator 106.

During the aforementioned TX time period, the adder 21 receives the transmission signal (baseband signal) fed back from the analog circuit 102. In addition, the adder 21 receives the compensation signal FB_{DC-OFFSET} from the DC leakage measurer 20. Then, the adder 21 adds the compensation signal FB_{DC-OFFSET} received from the DC leakage measurer 20 to the transmission signal fed back from the analog circuit 102. As a result, the DC leakage characteristics of the demodulator 106 of the TX are compensated. The transmission signal including the compensation signal FB_{DC-OFFSET} indicating the compensated DC leakage characteristics of the demodulator 106 is output to the baseband signal processing section 1.

For example, during a GAP time period after the aforementioned TX time period, the timing controller 2 continuously supplies the control signal indicating the first value to the DC leakage measurer 20. In this case, the DC leakage measurer 20 measures, based on the measured DC leakage characteristics of the demodulator 106 and the signal output from the analog circuit 102, DC leakage characteristics indicating the level (amplitude) and phase of DC leakage that occurs in the modulator 105 of the TX. Then, the DC leakage measurer 20 calculates reverse characteristics of the measured DC leakage characteristics.

For example, during the next TX time period, the timing controller 2 supplies the control signal indicating the first value to the DC leakage measurer 20 again. In this case, the DC leakage measurer 20 outputs, to the adder 11, the compensation signal TX_{DC-OFFSET} indicating the calculated reverse characteristics of the DC leakage characteristics of the modulator 105.

During the aforementioned TX time period, the adder 11 receives the transmission signal (baseband signal) output from the baseband signal processing section 1. In addition, the adder 11 receives the compensation signal TX_{DC-OFFSET} from the DC leakage measurer 20. Then, the adder 11 adds the compensation signal TX_{DC-OFFSET} to the received transmission signal. As a result, the DC leakage characteristics of the modulator 105 of the TX are compensated. The transmission signal including the compensation signal TX_{DC-OFFSET} indicating the compensated DC leakage characteristics of the modulator 105 of the TX is output from the analog circuit 102. Specifically, the transmission signal including the compensation signal TX_{DC-OFFSET} indicating the compensated DC leakage characteristics of the modulator 105 of the TX is output from the antenna 5 via the DAC 12, the modulator 105, the PA 15, the coupler 16, the circulator 3, and the BPF 4.

Example of Operations of Communication Device

Next, operations of the communication device 100 according to the first embodiment are described. The operations of the communication device 100 according to the first embodiment are classified into operations of the RX and operations of the TX and described below.

Operations of RX

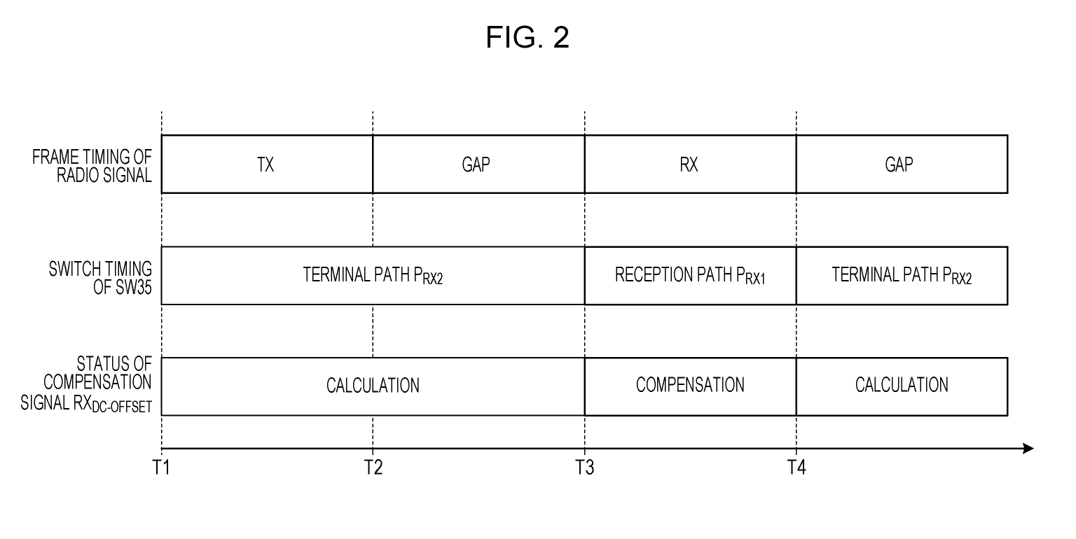

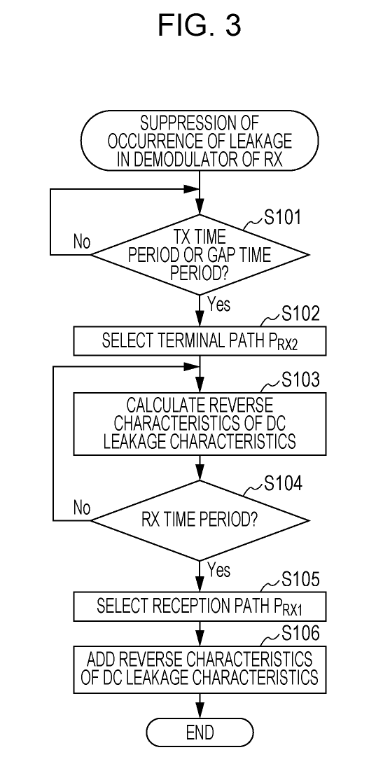

FIG. 2 is a timing chart of an example of the operations of the RX of the communication device 100 according to the first embodiment. FIG. 3 is a flowchart of the example of the operations of the RX of the communication device 100 according to the first embodiment.

The timing controller 2 determines whether the frame timing of a radio signal is in a TX time period or a GAP time period (in operation S101 illustrated in FIG. 3). If the frame timing of the radio signal is neither in the TX time period nor in the GAP time period (No in operation S101 illustrated in FIG. 3), the frame timing of the radio signal is in an RX time period.

For example, as illustrated in FIG. 2, at time T1, the frame timing of the radio signal is in the TX time period (Yes in operation S101 illustrated in FIG. 3). In this case, the timing controller 2 outputs the control signal indicating the first value to the RX-side distortion compensator 104. The SW 35 selects the terminal path P_{RX2} based on the control signal indicating the first value (in operation S102 illustrated in FIG. 3).

In the RX-side distortion compensator 104, the DC leakage measurer 30 receives a signal output from the analog circuit 102 based on the control signal indicating the first value. This signal is output from the demodulator 107 having the input terminated by the terminal path P_{RX2} via the ADC 32 to the digital signal processing section 101. The DC leakage measurer 30 measures, based on the signal output from the analog circuit 102, DC leakage characteristics indicating the level and phase of DC leakage that occurs in the demodulator 107 of the RX. Then, the DC leakage measurer 30 calculates reverse characteristics of the measured DC leakage characteristics in order to generate a compensation signal RX_{DC-OFFSET} (in operation S103 illustrated in FIG. 3).

As illustrated in FIG. 2, at time T2, the frame timing of the radio signal is switched from the TX time period to a GAP time period. In this case, since the frame timing of the radio signal is not in an RX time period (No in operation S104 illustrated in FIG. 3), operation S103 is executed.

As illustrated in FIG. 2, at time T3, the frame timing of the radio signal is switched from the GAP time period to an RX time period (Yes in operation S104 illustrated in FIG. 3). In this case, the timing controller 2 outputs the control signal indicating the second value to the SW 35 and the RX-side distortion compensator 104. The SW 35 selects the reception path P_{RX1} based on the control signal indicating the second value (in operation S105 illustrated in FIG. 3). In the RX-side distortion compensator 104, the DC leakage measurer 30 outputs, based on the control signal indicating the second value, the compensation signal RX_{DC-OFFSET} indicating the calculated reverse characteristics of the DC leakage characteristics (indicating the level and phase of the DC leakage) of the demodulator 107 to the adder 31.

In this case, the adder 31 receives a reception signal (baseband signal) output from the analog circuit 102. The reception signal is output from the antenna 5 via the BPF 4, the circulator 3, the ISO 37, the LNA 36, the reception path P_{RX1}, the SW 35, the demodulator 107, and the ADC 32 to the digital signal processing section 101. In addition, the adder 31 receives the compensation signal RX_{DC-OFFSET} from the DC leakage measurer 30. Then, in order to compensate for the DC leakage characteristics indicating DC leakage that occurs in the demodulator 107 of the RX, the adder 31 adds the compensation signal RX_{DC-OFFSET} received from the DC leakage measurer 30 to the reception signal output from the analog circuit 102 (in operation S106 illustrated in FIG. 3). The reception signal having the compensation signal RX_{DC-OFFSET} added thereto is output to the baseband signal processing section 1.

As illustrated in FIG. 2, at time T4, the frame timing of the radio signal is switched from the RX time period to a GAP time period (Yes in operation S101 illustrated in FIG. 3). In this case, operations S102 and later are executed.

Operations of TX

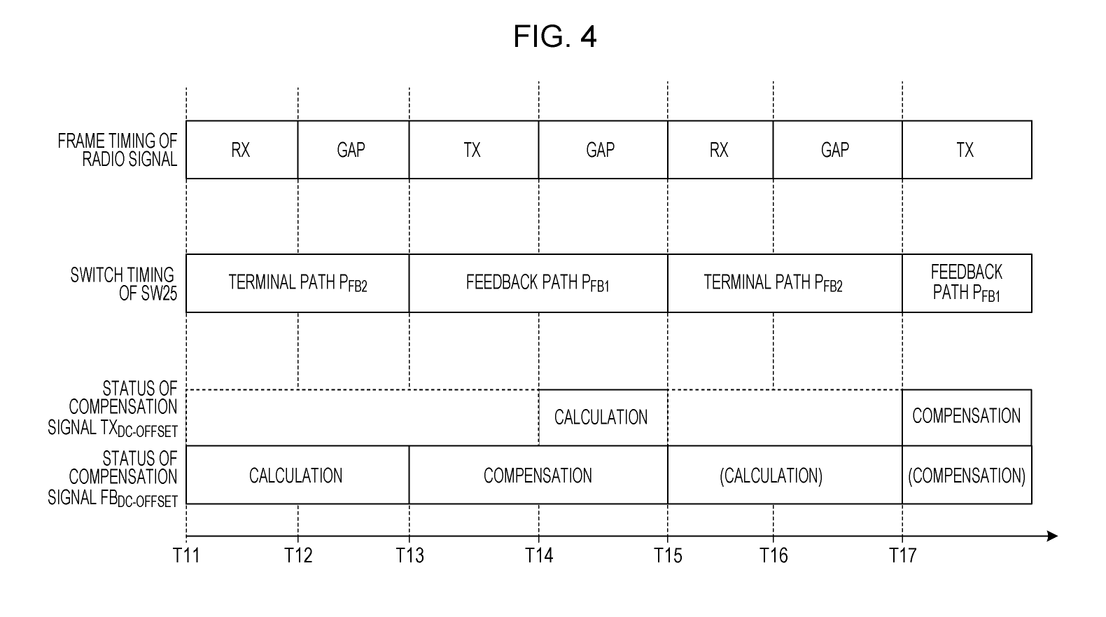

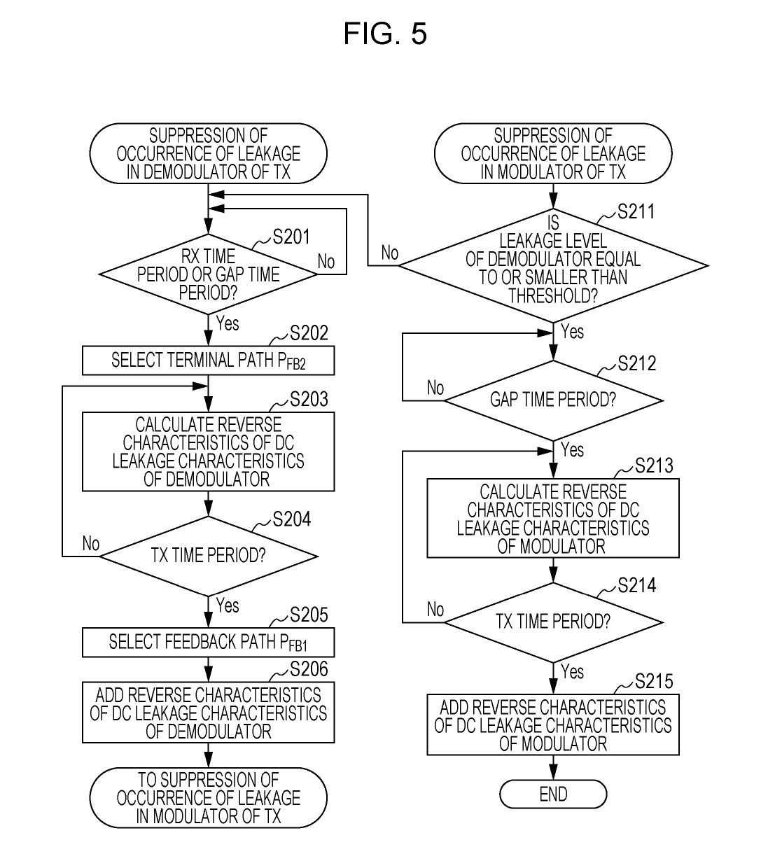

FIG. 4 is a timing chart of an example of the operations of the TX of the communication device 100 according to the first embodiment. FIG. 5 is a flowchart of the example of the operations of the TX of the communication device 100 according to the first embodiment.

The timing controller 2 determines whether the frame timing of a radio signal is in an RX time period or a GAP time period (in operation S201 illustrated in FIG. 5). If the frame timing of the radio signal is neither in the RX time period nor in the GAP time period (No in operation S201 illustrated in FIG. 5), the frame timing of the radio signal is in a TX time period.

For example, as illustrated in FIG. 4, at time T11, the frame timing of the radio signal is in the RX time period (Yes in operation S201 illustrated in FIG. 5). In this case, the timing controller 2 outputs the control signal indicating the second value to the SW 25 and the TX-side distortion compensator 103. The SW 25 selects the terminal path P_{FB2} based on the control signal indicating the second value (in operation S202 illustrated in FIG. 5).

In the TX-side distortion compensator 103, the DC leakage measurer 20 receives, based on the control signal indicating the second value, a signal output from the analog circuit 102. This signal is output from the demodulator 106 having the input terminated by the terminal path P_{FB2} via the ADC 22 to the digital signal processing section 101. The DC leakage measurer 20 measures, based on the signal output from the analog circuit 102, DC leakage characteristics indicating the level and phase of DC leakage that occurs in the TX-side distortion demodulator 106. Then, the DC leakage measurer 20 calculates reverse characteristics of the measured DC leakage characteristics in order to generate a compensation signal FB_{DC-OFFSET} (in operation S203 illustrated in FIG. 5).

As illustrated in FIG. 4, at time T12, the frame timing of the radio signal is switched from the RX time period to a GAP time period. In this case, since the frame timing of the radio signal is not in a TX time period (No in operation S204 illustrated in FIG. 5), operation S203 is executed.

As illustrated in FIG. 4, at time T13, the frame timing of the radio signal is switched from the GAP time period to a TX time period (Yes in operation S204 illustrated in FIG. 5). In this case, the timing controller 2 outputs the control signal indicating the first value to the SW 25 and the TX-side distortion compensator 103. The SW 25 selects the feedback P_{FB1} based on the control signal indicating the first value (in operation S205 illustrated in FIG. 5). In the TX-side distortion compensator 103, the DC leakage measurer 20 outputs, based on the control signal indicating the first value, the compensation signal FB_{DC-OFFSET} indicating the calculated reverse characteristics of the DC leakage characteristics (indicating the level and phase of the DC leakage) of the demodulator 106 to the adder 21.

In this case, the adder 21 receives a transmission signal (baseband signal) from the analog circuit 102. The transmission signal is fed back from the digital signal processing section 101 via the DAC 12, the modulator 105, the PA 15, the coupler 16, the feedback path P_{FB1}, the SW 25, the demodulator 106, and the ADC 22 to the digital signal processing section 101. In addition, the adder 21 receives the compensation signal FB_{DC-OFFSET} from the DC leakage measurer 20. Then, in order to compensate for the DC leakage characteristics indicating the DC leakage that occurs in the demodulator 106 of the TX, the adder 21 adds the compensation signal FB_{DC-OFFSET} received from the DC leakage measurer 20 to the transmission signal fed back from the analog circuit 102 (in operation S206 illustrated in FIG. 5). The transmission signal including the compensation signal FB_{DC-OFFSET} indicating the compensated DC leakage characteristics of the demodulator 106 is output to the baseband signal processing section 1.

If the compensation of the DC leakage characteristics indicating the DC leakage that occurs in the demodulator 106 has not been completed or, for example, the level (leakage level) indicated by the DC leakage characteristics exceeds a threshold (No in operation S211 illustrated in FIG. 5), operations S201 and later are executed. For example, as illustrated in FIG. 4, in the case where the frame timing of the radio signal is in an RX time period at time T15 and is in a GAP time period at time T16, the reverse characteristics of the DC leakage characteristics (indicating the level and phase of the DC leakage) of the demodulator 106 are calculated in order to generate the compensation signal FB_{DC-OFFSET}. In addition, as illustrated in FIG. 4, in the case where the frame timing of the radio signal is in a TX time period at time T17, the compensation signal FB_{DC-OFFSET} is added to the transmission signal fed back from the analog circuit 102 in order to compensate for the DC leakage characteristics of the demodulator 106.

If the compensation of the DC leakage characteristics indicating DC leakage that occurs in the demodulator 106 has been completed or, for example, the level (leakage level) indicated by the DC leakage characteristics exceeds the threshold (Yes in operation S211 illustrated in FIG. 5), the timing controller 2 determines whether or not the frame timing of the radio signal is in a GAP time period (in operation S212 illustrated in FIG. 5). If the current time does not reach time T14, the frame timing of the radio signal is not in the GAP time period (No in operation S212 illustrated in FIG. 5) and is still in the TX time period.

For example, as illustrated in FIG. 4, if the current time reaches time T14, the frame timing of the radio signal is switched from the TX time period to the GAP time period (Yes in operation S212 illustrated in FIG. 5). In this case, the timing controller 2 continuously outputs the control signal indicating the first value to the SW 25 and the TX-side distortion compensator 103. In addition, the SW 25 selects the feedback path P_{FB1} based on the control signal indicating the first value.

In the TX-side distortion compensator 103, the DC leakage measurer 20 receives the signal output from the analog circuit 102 based on the control signal indicating the first value. This signal is output from the modulator 105 via the PA 15, the coupler 16, the feedback path P_{FB1}, the SW 25, the demodulator 106, and the ADC 22 to the digital signal processing section 101. The DC leakage measurer 20 measures, based on the measured DC leakage characteristics of the demodulator 106 and the signal output from the analog circuit 102, DC leakage characteristics indicating the level and phase of DC leakage that occurs in the modulator 105 of the TX. Then, the DC leakage measurer 20 calculates reverse characteristics of the measured DC leakage characteristics (in operation S213 illustrated in FIG. 5).

As illustrated in FIG. 4, the frame timing of the radio signal is switched from the GAP time period to the RX time period at time T15 and is switched from the RX time period to the GAP time period at time T16. In other words, the frame timing of the radio signal is not in a TX time period (No in operation S214 illustrated in FIG. 5).

As illustrated in FIG. 4, at time T17, the frame timing of the radio signal is switched from the GAP time period to the TX time period (Yes in operation S214 illustrated in FIG. 5). In this case, the timing controller 2 outputs the control signal indicating the first value to the SW 25 and the TX-side distortion compensator 103. In this case, in the TX-side distortion compensator 103, the DC leakage measurer 20 outputs, based on the control signal indicating the first value, a compensation signal TX_{DC-OFFSET} indicating the calculated reverse characteristics of the DC leakage characteristics of the modulator 105 to the adder 11.

In addition, the adder 11 receives the transmission signal (baseband signal) output from the baseband signal processing section 1. Furthermore, the adder 11 receives the compensation signal TX_{DC-OFFSET} from the DC leakage measurer 20. Then, in order to compensate for the DC leakage characteristics indicating DC leakage that occurs in the modulator 105 of the TX, the adder 11 adds the compensation signal TX_{DC-OFFSET} to the received transmission signal (in operation S215 illustrated in FIG. 5). The transmission signal including the compensation signal TX_{DC-OFFSET} indicating the compensated DC leakage characteristics of the modulator 105 of the TX is output from the analog circuit 102. Specifically, the transmission signal including the compensation signal TX_{DC-OFFSET} indicating the compensated DC leakage characteristics of the modulator 105 of the TX is output from the analog circuit 102 via the DAC 12, the modulator 105, the PA 15, the coupler 16, the circulator 3, and the BPF 4.

### Effects of First Embodiment

As described above, the communication device 100 according to the first embodiment includes the transmitter (TX) that transmits a transmission signal during a transmission time period (TX time period) and the receiver that receives a reception signal during a reception time period (RX time period). The TX includes the transmission-side distortion compensator (TX-side distortion compensator 103) and the modulator 105 that modulates the transmission signal. The TX-side distortion compensator 103 measures spurious characteristics (DC leakage characteristics) of the modulator 105 during time periods (RX time period and GAP time period) other than TX time periods and adds a compensation signal TX_{DC-OFFSET} indicating reverse characteristics of the DC leakage characteristics of the modulator 105 to the transmission signal before the input of the transmission signal to the modulator 105 during a TX time period. The RX includes the reception-side distortion compensator (RX-side distortion compensator 104) and the demodulator 107 that demodulates a reception signal. The RX-side distortion compensator 104 measures spurious characteristics (DC leakage characteristics) of the demodulator 107 during time periods (TX time period and GAP time period) other than RX time periods and adds a compensation signal RX_{DC-OFFSET} indicating reverse characteristics of the DC leakage characteristics of the demodulator 107 to the reception signal output from the demodulator 107 during an RX time period.

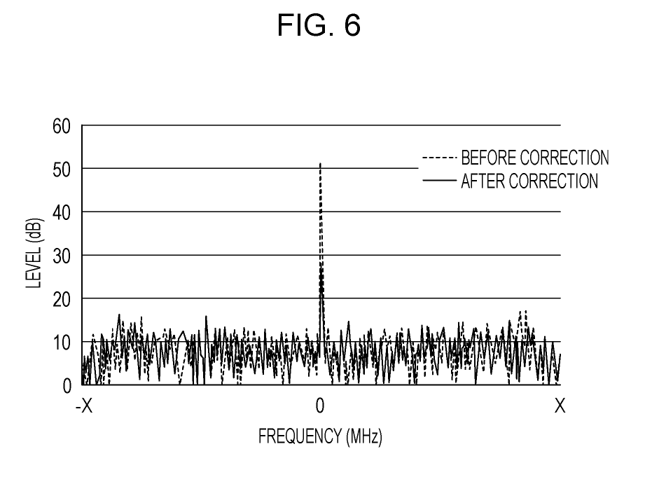

The RX-side distortion compensator 104 measures the DC leakage characteristics of the demodulator 107 based on the output of the demodulator 107 upon the termination of the input of the demodulator 107 during time periods (TX time period and GAP time period) other than RX time periods. The RX-side distortion compensator 104 adds the compensation signal RX_{DC-OFFSET} indicating the reverse characteristics of the DC leakage characteristics of the demodulator 107 to the reception signal output from the demodulator 107 during an RX time period. Similarly, in the case where the TX-side distortion compensator 103 measures the spurious characteristics (DC leakage characteristics) of the modulator 105, it is sufficient if the transmission signal is fed back from the output of the modulator 105. In this case, the TX has the transmission-side demodulator (demodulator 106) for demodulating the signal fed back from the output of the modulator 105, and the transmission signal fed back from the output of the modulator 105 is demodulated by the demodulator 106. The demodulator 106, however, includes the local oscillator and the frequency converter, like the modulator 105. Thus, as illustrated in FIG. 6, the DC leakage characteristics of the modulator 105 and the DC leakage characteristics of the demodulator 106 are synthesized with the transmission signal (refer to a dotted line illustrated in FIG. 6) that is in a state before correction and is to be output from the demodulator 106 to the baseband signal processing section 1.

Thus, in the communication device 100 according to the first embodiment, the TX-side distortion compensator 103 measures the DC leakage characteristics of the demodulator 106 based on the output of the demodulator 106 upon the termination of the input of the demodulator 106 during time periods (RX time period and GAP time period) other than TX time periods. Next, during a time period other than TX time periods, the TX-side distortion compensator 103 measures the DC leakage characteristics of the modulator 105 based on the DC leakage characteristics of the demodulator 106 and the output of the demodulator 106 when the demodulator 106 receives the signal fed back from the output of the modulator 105. Then, during a TX time period, the TX-side distortion compensator 103 adds the compensation signal TX_{DC-OFFSET} indicating the reverse characteristics of the DC leakage characteristics of the modulator 105 to the transmission signal before the input of the transmission signal to the modulator 105. Thus, as illustrated in FIG. 6, in the transmission signal (refer to a solid line illustrated in FIG. 6) that is in the state after the correction and is to be output from the demodulator 106 to the baseband signal processing section 1, the DC leakage characteristics of the modulator 105 and the DC leakage characteristics of the demodulator 106 are attenuated, compared with those before the correction.

In this manner, in the communication device 100 according to the first embodiment, a distortion, caused by a spurious emission (DC leakage), of a transmission signal may be compensated without the use of a filter such as a high-pass filter. It is, therefore, possible to take full advantage of a frequency band of the modulator 105 and the demodulator 106. In addition, a spurious emission may rapidly change due to a temperature. In the communication device 100 according to the first embodiment, however, a distortion of a transmission signal may be compensated in accordance with a change in the temperature by switching between a time period (RX time period or GAP time period) other than a TX time period and the TX time period.

In the communication device 100 according to the first embodiment, the RX includes the switch (SW 35). During time periods (TX time period and GAP time period) other than RX time periods, when the RX-side distortion compensator 104 measures the DC leakage characteristics of the demodulator 107, the SW 35 switches to the path (terminal path P_{RX2}) for terminating the input of the demodulator 107. On the other hand, during an RX time period, the SW 35 switches to the path (reception path P_{RX1}) for outputting a reception signal to the demodulator 107. In addition, the TX includes the switch (SW 25). During time periods (RX time period and GAP time period) other than TX time periods, when the TX-side distortion compensator 103 measures the DC leakage characteristics of the demodulator 106, the SW 25 switches to the path (terminal path P_{FB2}) for terminating the input of the demodulator 106. On the other hand, during a time period (GAP time period) other than TX time periods, when the TX-side distortion compensator 103 measures the DC leakage characteristics of the modulator 105, the SW 25 switches to the feedback path P_{FB1}. The feedback path P_{FB1} is a path for outputting a transmission signal fed back from the output of the modulator 105 to the demodulator 106.

In this manner, the communication device 100 according to the first embodiment uses the SW 35 to distinguish between a reception signal received by the RX and DC leakage that occurs in the demodulator 107 of the analog circuit 102 of the RX. In addition, the communication device 100 according to the first embodiment uses the SW 25 to distinguish between DC leakage that occurs in the modulator 105 of the analog circuit 102 of the TX and DC leakage that occurs in the demodulator 106 of the analog circuit 102 of the TX.

The communication device 100 according to the first embodiment includes the RX and the TX that share the antenna 5, but is not limited to this. In the communication device 100 according to the first embodiment, antennas 5 may be installed for the RX and the TX, respectively.

The communication device 100 according to the first embodiment includes the SWs, but is not limited to this. For example, the SW 35 may not be installed, and a power supply of the LNA 36 may be turned off upon the termination of the input of the demodulator 107 of the RX.

In the communication device 100 according to the first embodiment, the SW 35 and the SW 25 are installed for the RX and the TX, respectively. In the communication device 100 according to the first embodiment, however, an SW may be shared by the RX and the TX. An embodiment in which the SW is shared by the RX and the TX is described as a second embodiment. In the second embodiment, configurations that are the same as those described in the first embodiment are indicated by the same reference symbols as those described in the first embodiment, and a description of the duplicated configurations and duplicated operations is omitted.

### Second Embodiment

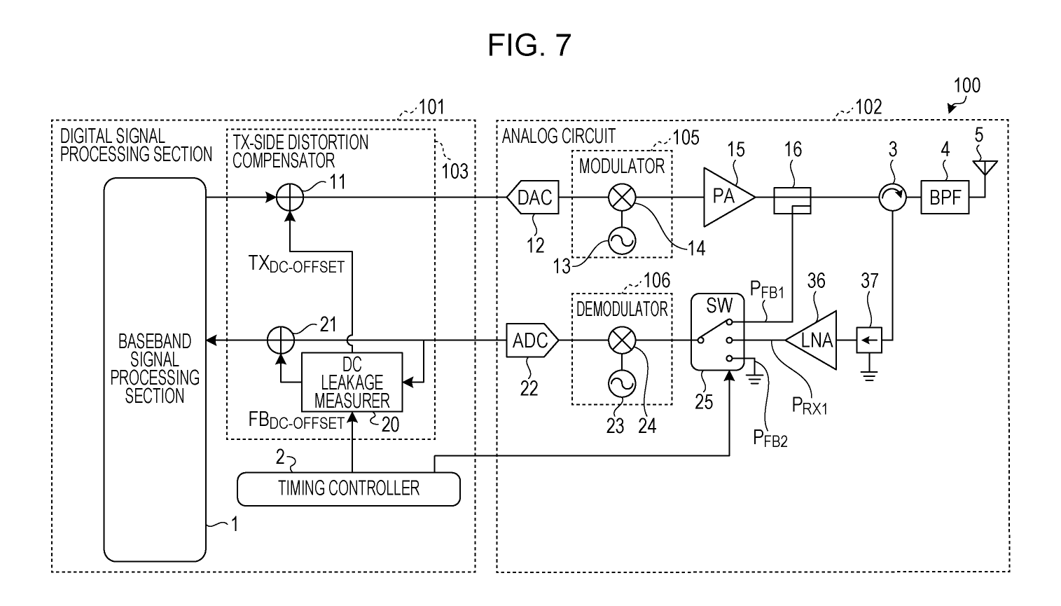

FIG. 7 is a diagram illustrating an example of a communication device 100 according to the second embodiment. In the communication device 100 according to the second embodiment, the baseband signal processing section 1, the timing controller 2, the adder 21, the DC leakage measurer 20, the ADC 22, the demodulator 106 (including the LO 23 and the frequency converter 24), and an SW 25 are shared by the RX and the TX.

In this case, the SW 25 includes three inputs and one output. A first input of the SW 25 is connected to the output of the coupler 16 via the feedback path P_{FB1}. A second input of the SW 25 is connected to the output of the LNA 36 via the reception path P_{RX1}. A third input of the SW 25 is terminated (grounded) via the terminal path P_{FB2} (or may be terminated (grounded) via the terminal path P_{RX2}).

For example, during time periods (TX time period and GAP time period) other than RX time periods, when the TX-side distortion compensator 103 measures the DC leakage characteristics of the demodulator 106, the timing controller 2 outputs, to the SW 25, the control signal for selecting the terminal path P_{RX2}.

For example, during an RX time period, the timing controller 2 outputs, to the SW 25, the control signal for selecting the reception path P_{Rx1}.

For example, during a time period (GAP time period) other than TX time periods, when the TX-side distortion compensator 103 measures the DC leakage characteristics of the modulator 105, the timing controller 2 outputs, to the SW 25, the control signal for selecting the feedback path P_{FB1}. In addition, during a TX time period, the timing controller 2 outputs, to the SW 25, the control signal for selecting the feedback path P_{FB1}.

As described above, the communication device 100 according to the second embodiment includes the SW 25 having the three inputs. In this case, the demodulator 106 functions as the demodulator 107. During time periods (TX time period and GAP time period) other than RX time periods, when the TX-side distortion compensator 103 measures the DC leakage characteristics of the demodulator 106, the SW 25 switches to the path (terminal path P_{RX2}) for terminating the input of the demodulator 106. In addition, during an RX time period, the SW 25 switches to the path (reception path P_{RX1}) for outputting a reception signal to the demodulator 106. In addition, during a time period (GAP time period) other than TX time periods, when the TX-side distortion compensator 103 measures the DC leakage characteristics of the modulator 105, the SW 25 switches to the feedback path P_{FB1}. The feedback path P_{FB1} is a path for outputting a transmission signal fed back from the output of the modulator 105 to the demodulator 106. Thus, the communication device 100 according to the second embodiment produces the effects described in the first embodiment and enables the demodulator 106 to be shared by the TX and the RX.

### Other Embodiments

The constituent elements of the sections illustrated in the drawings in the first and second embodiments may not be physically configured as illustrated in the drawings. In other words, specific forms of distribution and integration of the sections are not limited to those illustrated in the accompanying drawings, and the sections may be configured in arbitrary units by functionally or physically distributing and integrating all or a part of the sections based on various loads, usage states, and the like.

In addition, all or an arbitrary part of the various processes to be executed by the devices may be executed on a central processing unit (CPU) (or a microcomputer such as a micro processing unit (MPU) or a micro controller unit (MCU)). In addition, all or an arbitrary part of the various processes may be executed on a program analyzed and executed by the CPU (or the microcomputer such as the MPU or the MCU) or may be executed on hardware achieved by wired logic.

The communication devices 100 according to the first and second embodiments may be achieved by such a hardware configuration as described below.

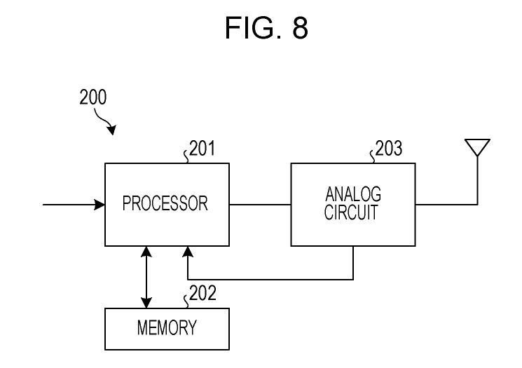

FIG. 8 is a diagram illustrating an example of a hardware configuration of a communication device 200. The communication device 200 includes a processor 201, a memory 202, and an analog circuit 203. Examples of the processor 201 are a CPU, a digital signal processor (DSP), and a field programmable gate array (FPGA). Examples of the memory 202 are a random access memory (RAM) such as a synchronous dynamic random access memory (SDRAM), a read only memory (ROM), and a flash memory.

The various processes to be executed in the communication devices 100 according to the first and second embodiments may be achieved by causing the processor to execute programs stored in various memories including a nonvolatile storage medium. Specifically, the programs corresponding to the processes to be executed by the digital signal processing section 101 may be stored in the memory 202 and executed by the processor 201. In addition, the analog circuit 102 is achieved by the analog circuit 203.

The various processes to be executed in the communication devices 100 according to the first and second embodiments are executed by the processor 201, but are not limited to this. The various processes to be executed in the communication devices 100 according to the first and second embodiments may be executed by multiple processors.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a transmitter that transmits a transmission signal during a transmission time period, the transmitter configured to include:
a modulator configured to modulate the transmission signal, and
a transmission-side distortion compensator configured to measure spurious characteristics of the modulator during a time period other than the transmission time period and add, during the transmission time period, a compensation signal indicating reverse characteristics of the spurious characteristics of the modulator to the transmission signal before the input of the transmission signal to the modulator, and
a receiver that receives a reception signal during a reception time period, the receiver configured to include:
a demodulator configured to demodulate the reception signal, and
a reception-side distortion compensator configured to measure spurious characteristics of the demodulator during a time period other than the reception time period and adds, during the reception time period, a compensation signal indicating reverse characteristics of the spurious characteristics of the demodulator to the reception signal output from the demodulator.

2. The communication device according to claim 1,
wherein the reception-side distortion compensator measures, during the time period other than the reception time period, the spurious characteristics of the demodulator based on an output of the demodulator upon the termination of an input of the demodulator and adds, during the reception time period, the compensation signal indicating the reverse characteristics of the spurious characteristics of the demodulator to the reception signal output from the demodulator,
wherein the transmitter includes a transmission-side demodulator that demodulates a signal fed back from an output of the modulator,
wherein the transmission-side distortion compensator measures spurious characteristics of the transmission-side demodulator based on an output of the transmission-side demodulator upon the termination of an input of the transmission-side demodulator and measures the spurious characteristics of the modulator based on the output of the transmission-side demodulator upon the input of the signal fed back from the output of the modulator to the transmission-side demodulator during the time period other than the transmission time period, and
wherein the transmission-side distortion compensator adds the compensation signal indicating the reverse characteristics of the spurious characteristics of the modulator to the transmission signal before the input of the transmission signal to the modulator during the transmission time period.

3. The communication device according to claim 2,
wherein the receiver includes a switch that switches to a path for terminating the input of the demodulator when the reception-side distortion compensator measures the spurious characteristics of the demodulator during the time period other than the reception time period, and that switches to a path for outputting the reception signal to the demodulator during the reception time period, and
wherein the transmitter includes a switch that switches to a path for terminating the input of the transmission-side demodulator when the transmission-side distortion compensator measures the spurious characteristics of the transmission-side demodulator during the time period other than the transmission time period, and that switches to a path for outputting the signal fed back from the output of the modulator to the transmission-side demodulator.

4. The communication device according to claim 2,
wherein the transmission-side demodulator functions as the demodulator,
wherein the communication device further comprises a switch that switches to a path for terminating the input of the transmission-side demodulator when the transmission-side distortion compensator measures the spurious characteristics of the transmission-side demodulator during the time period other than the reception time period, and that switches to a path for outputting the reception signal to the transmission-side demodulator during the reception time period, and that switches to a path for outputting the signal fed back from the output of the modulator to the transmission-side demodulator when the transmission-side distortion compensator measures the spurious characteristics of the modulator during the time period other than the transmission time period.

5. A distortion compensation method for a communication device that transmits a transmission signal during a transmission time period and receives a reception signal during a reception time period, the distortion compensation method comprising:
first measuring, during a time period other than the transmission time period, spurious characteristics of a modulator that modulates the transmission signal;
first adding, during the transmission time period, a first compensation signal indicating reverse characteristics of the spurious characteristics of the modulator to the transmission signal before the input of the transmission signal to the modulator;
second measuring, during a time period other than the reception time period, spurious characteristics of a demodulator that demodulates the reception signal; and
second adding, during the reception time period, a second compensation signal indicating reverse characteristics of the spurious characteristics of the demodulator to the reception signal output from the demodulator.

6. The distortion compensation method according to claim 5, further comprising:
first terminating an input of the modulator during the time period other than the transmission time period; and
second terminating an input of the demodulator during the time period other than the reception time period.

7. The distortion compensation method according to claim 5, further comprising:
providing a feedback signal from the output of the modulator to a processor to compensate for the spurious characteristics of the modulator; and
switching an input of the demodulator to a path for terminating the input of the demodulator when the processor measures the spurious characteristics of the demodulator during the time period other than the reception time period, to a path for outputting the reception signal to the demodulator during the reception time period, and to a path for outputting the feedback signal from the output of the modulator to the demodulator when the first measuring measures the spurious characteristics of the modulator during the time period other than the transmission time period.

8. A communication device comprising:
an analog circuit including a demodulator; and
a processor to compensate for spurious characteristics of the demodulator, the processor configured to
measure the spurious characteristics of an output signal of the demodulator during a time period in which an input signal to the demodulator is not being demodulated,
generate a compensation signal indicating reverse characteristics of the measured spurious characteristics; and
adding the compensation signal to a communicated signal to compensate for the spurious characteristics of the demodulator.

9. The communication device according to claim 8, wherein the input signal being demodulated is a reception signal received by the communication device during a receiving time period and the processor measures the spurious characteristics during the time period other than the receiving time period.

10. The communication device according to claim 9, wherein an input terminal of the demodulator is terminated during the time period other than the receiving time period.

11. The communication device according to claim 8, wherein the input signal being demodulated is a feedback signal during a transmission time period and the processor measures the spurious characteristics during the time period other than the transmission time period.

12. The communication device according to claim 11, wherein an input terminal of the demodulator is terminated during the time period other than the transmission time period.

13. The communication device according to claim 8, wherein
the analog circuit further includes a modulator configured to modulate a transmission signal during a transmission time period, and
the processor is further configured to
measure spurious characteristics of the modulator during a time period other than the transmission time period,
generates a second compensation signal indicating reverse characteristics of the spurious characteristics of the modulator, and
adds, during the transmission time period, the second compensation signal to the transmission signal before the input of the transmission signal to the modulator.

14. The communication device according to claim 13, wherein the analog circuit further comprises a switch configured to
switch to a path for terminating the input of the demodulator when the processor measures the spurious characteristics of the demodulator during the time period other than a reception time period during which a reception signal to the communication device is received,
switch to a path for outputting the reception signal to the demodulator during the reception time period, and
switch to a path for outputting a signal fed back from the output of the modulator to the demodulator when the processor measures the spurious characteristics of the modulator during the time period other than the transmission time period.

15. The communication device according to claim 8, wherein
the demodulator is a reception demodulator demodulating a reception signal during a reception time period and the analog signal further includes:
a modulator configured to modulate a transmission signal during a transmission time period, and
a feedback demodulator to demodulate a feedback signal during the transmission time period, wherein
the processor is further configured to
measure spurious characteristics of the modulator during a time period other than the transmission time period,
generate a second compensation signal indicating reverse characteristics of the spurious characteristics of the modulator,
add, during the transmission time period, the second compensation signal to the transmission signal before the input of the transmission signal to the modulator,
measure spurious characteristics of the feedback demodulator when an input of the feedback demodulator is terminated,
generate a third compensation signal indicating reverse characteristics of the feedback demodulator, and
add the third compensation signal to the demodulated feedback signal.

16. The communication device according to claim 15, wherein the analog circuit further includes:
a first switch connected to an input of the reception demodulator, the first switch configured to connect the input of the reception demodulator to a reception signal path receiving a reception signal during a receiving time period and to connect the input of the reception demodulator to a termination path to terminate the input of the reception demodulator when the processor measures the spurious characteristics of the reception modulator; and
a second switch configured to connect an input of the feedback demodulator to a feedback path during the transmission time period and to connect the input of the feedback demodulator to the termination path to terminate the input of the feedback demodulator when the processor measures the spurious characteristics of the feedback demodulator.

17. The communication device according to claim 8, further comprising:
a switch that switches from a path providing the input signal to the demodulator to a path terminating an input of the demodulator when the processor measures the spurious characteristics of the demodulator.
